(19) United States
(12) Patent Application Publication
(10) Pub. No.: US 2009/0223776 A1
(43) Pub. Date: Sep. 10, 2009

(54) BILL ACCEPTOR WITH LICENCE/BILL RECOGNITION

(75) Inventors: Ting-Kuo Lin, Toayuan (TW); Wei Chiu, Taipei (TW); Yueh-Ping Hsu, Taipei (TW); Chi-Tsung Lee, Taipei (TW); Sung-Ching Lin, Taipei (TW)

Correspondence Address: INTERNATIONAL CURRENCY TECHNOLOGIES CORPORATION, 2F-4. NO. 148, SEC. 4, CHUNG HSIAN EAST ROAD, TAIPEI, TW

(73) Assignee: INTERNATIONAL CURRENCY TECHNOLOGIES CORPORATION, Taipei City (TW)

(21) Appl. No.: 12/042,341

(22) Filed: Mar. 5, 2008

(51) Int. Cl. G07F 7/04

(52) U.S. Cl. 194/206

(57) ABSTRACT

A bill acceptor for use in an automatic vending machine for selling controlled commodities is disclosed to include a bill acceptor body having an insertion slot for the insertion of a license as well as a bill and a passage extending from the insertion slot, a transmission mechanism for carrying each inserted license and bill to a respective recognition position for recognition and returning each inserted invalid license to the insertion slot, and a license and bill recognition unit that comprises a sampling module for picking up an image of each inserted license and recognizing the authenticity of the license and the data of the date of birth carried on the license and an optical recognition module for recognizing the authenticity and value of each inserted bill.

### BACKGROUND OF THE INVENTION

1. Field of the Invention

The present invention relates to bill acceptors and more particularly, to a bill acceptor practical for use in an automatic vending machine to control selling of controlled commodities to persons over the legal age.

2. Description of the Related Art

Following fast development of technology, our mode of living has been changed, and different automatic vending machines are used everywhere to sell different products without serviceman. These automatic vending machines are highly invited for the advantage of saving much labor and bringing convenience to people.

Further, Q-shop has the advantages of scientific intelligence, quick service and quick finish of payment. A Q-shop may provide automatic vending machines for vending drinks, cigarettes, tickets, ice creams, memorial coins, key rings or even hamburgers and noodles. Nowadays, many virtual shops are established to make online shopping, allowing shoppers to shop across millions of products.

However, regular vending machines do not limit the sales to any person of any age. Therefore, regular vending machines commonly sell popular goods such as fruit juice beverages, carbonated beverages, food, etc. These vending machines cannot sell age-controlled merchandises such as cigarettes or alcohol drinks, or other controlled merchandises such as drugs, strong acids/alkalines detergent or other hazardous items. To prohibit young children from buying age-controlled merchandises or unqualified people from buying controlled items, a vending machine for vending age-controlled or controlled merchandises must be equipped with a security system to recognize the age or identification of the consumer.

Following development of technology and establishment of license systems, people may need to obtain different licenses for different qualifications. One person may carry many different licenses. However, regular licenses can easily be copied. In order to prevent counterfeit, anti-counterfeit techniques are developed and applied to issue of licenses. There is known a license authenticity checking device for automatic vending machine that verifies the authenticity of a license by means of radiating the license with two or more different wavelength lights and then checking the variation of amplitude thus produced for further comparison with anti-counterfeit reference data.

Therefore, designing an automatic vending machine for vending age-controlled or specifically controlled merchandises must consider the recognition of the customers' real age or identity. The customer must insert a personal identification card (such as driver license, ID card, IC card, etc.) into the machine for checking the real age and/or identity. The automatic vending machine allows the transaction only when the customer's age or identify is verified and approved. However, the problem of counterfeit licenses must be taken into account and prevented. Following fast development of computer technology, evil persons may use computer scanning, copying and printing technology to make counterfeit licenses for cheating money or goods from venders. Therefore, an automatic vending machine for vending age-controlled or specifically controlled merchandises must be equipped with a high-performance license checker to verify different characteristics (water mark, paper quality, personal data, etc.), assuring safety.

However, for vending age-controlled commodities, an automatic vending machine must be equipped with a bill acceptor as well as a license recognition unit. Because the bill acceptor and the license recognition unit in an automatic vending machine are two separated devices, the automatic vending machine must a certain dimension for accommodating these two separated devices. Further, the installation of the bill acceptor and the license recognition unit greatly increase the cost of the automatic vending machine.

### SUMMARY OF THE INVENTION

The present invention has been accomplished under the circumstances in view. According to one aspect of the present invention, the bill acceptor is practical for use in an automatic vending machine to control selling of controlled commodities to persons over the legal age. The bill acceptor comprises a bill acceptor body having an insertion slot for the insertion of a license as well as a bill and a passage extending from the insertion slot, a transmission mechanism for carrying each inserted license and bill to a respective recognition position for recognition and returning each inserted invalid license to the insertion slot, and a license and bill recognition unit that comprises a sampling module for picking up an image of each inserted license and recognizing the authenticity of the license and the data of the date of birth carried on the license and an optical recognition module for recognizing the authenticity and value of each inserted bill.

According to another aspect of the present invention, the bill acceptor utilizes the insertion slot and the passage for the insertion of a license as well as a bill, and the transmission mechanism carries the inserted license or bill into position for recognition and returns the inserted license or bill to the insertion slot if the inserted license or bill is a counterfeit. Because the bill acceptor of the present invention can recognize licenses as well as bills, the use of the bill acceptor in an automatic vending machine saves much the installation space. Further, because the invention utilizes one single insertion slot, passage and transmission mechanism for receiving and carrying licenses and bills, the manufacturing cost of the bill acceptor is greatly lowered.

According to still another aspect of the present invention, when a user inserts a license into the insertion slot, the transmission mechanism immediately carries the inserted license into position for recognition by the license and bill recognition unit. After recognition, the transmission mechanism automatically returns the license to the insertion slot so that the user can withdraw the license from the insertion slot. When the license is recognized to be a true license and the related data of the license has been recorded, the user is allowed to insert a bill into the insertion slot to make a transaction. Because a user can insert a bill into the insertion slot only after he (she) has inserted the license into the insertion slot for recognition and withdrew the license after completion of recognition of the license, the invention prevents the problem that the user forgets to withdraw the license. If one's license is left in an automatic vending machine, an evil person may take away the license for illegal purpose. By means of the use of the bill acceptor of the present invention, an automatic vending machine eliminates this possibility.

### BRIEF DESCRIPTION OF THE DRAWINGS

FIG. 1 is an elevational view of a bill acceptor according to the present invention.

FIG. 2 is an exploded view of a part of the bill acceptor in accordance with the present invention.

FIG. 3 is a sectional side view of the bill acceptor in accordance with the present invention.

FIG. 4 is a schematic sectional side view of the present invention, showing a license inserted into the bill acceptor and carried forwards according to the present invention.

FIG. 5 is a schematic sectional side view of the present invention, showing a bill inserted into the bill acceptor and carried forwards according to the present invention.

FIG. 6 is an operation flow of the bill acceptor according to the present invention (I).

FIG. 7 is an operation flow of the bill acceptor according to the present invention (II).

### DETAILED DESCRIPTION OF THE PREFERRED EMBODIMENT

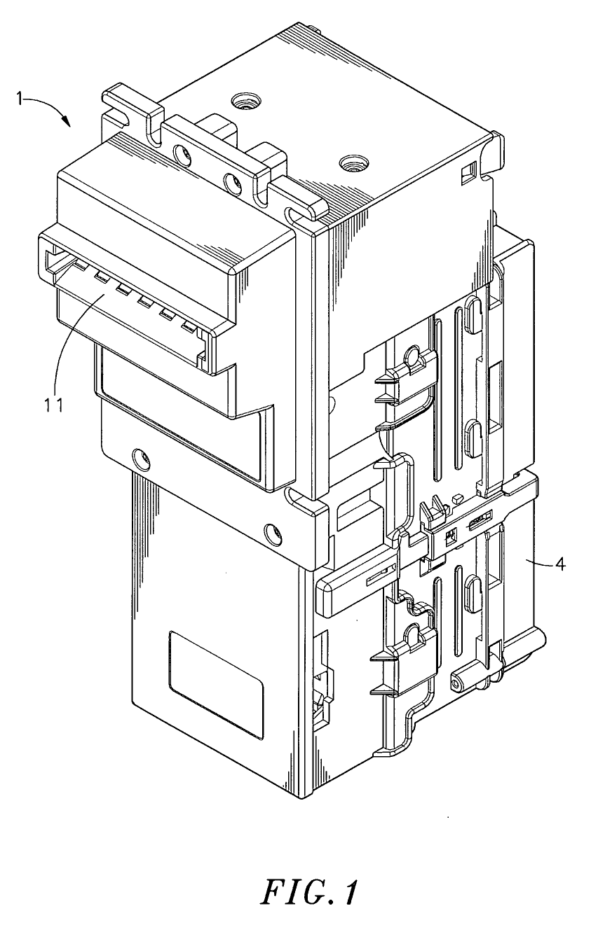

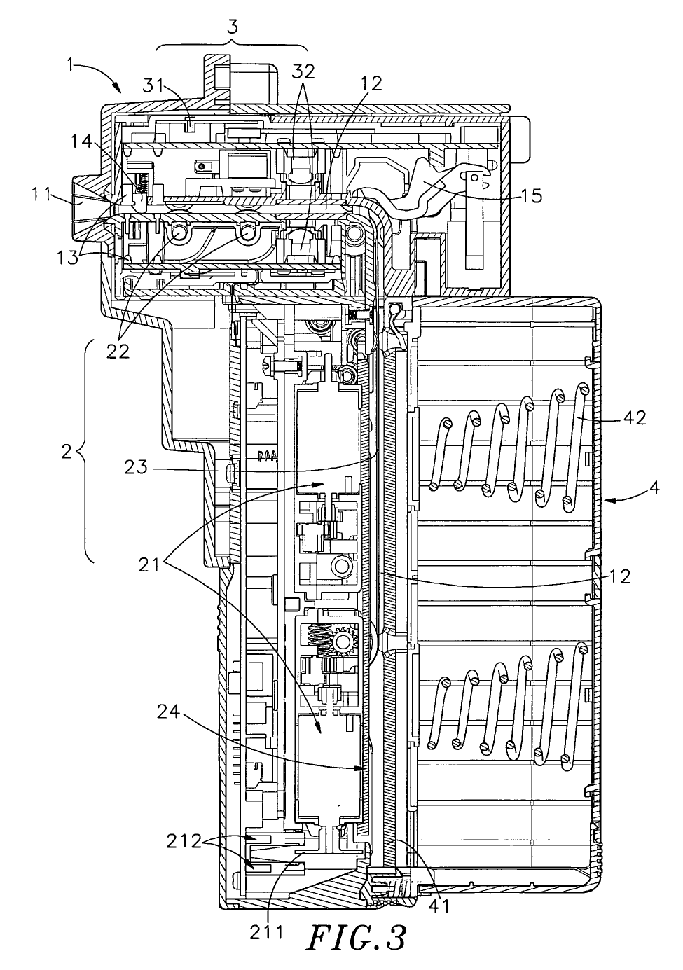

Referring to FIGS. 1-3, a bill acceptor in accordance with the present invention is shown comprising a bill acceptor body 1. The bill acceptor body 1 has mounted therein a transmission mechanism 2, a license and bill recognition unit 3 and a bill box 4.

The bill acceptor body 1 has an insertion slot 11 for the insertion of a bill or license, a passage 12 extending backwards from the insertion slot 11 toward the transmission mechanism 2, sensor switches 13 installed in two opposing sides near the junction between the insertion slot 11 and the passage 12, a light-shielding gate 14 set between the sensor switches 13, and an anti-theft hook 15 at the turn on the midway of the passage 12.

The transmission mechanism 2 is arranged around the passage 12 at two sides, comprising a motor 21, transfer rollers 22 and transmission belts 23 rotatable by the motor 21 to transfer the inserted bill, a set of optical wheel 211 and sensor 212 adapted for counting the revolving speed of the transfer rollers 22, and a bill-pressing device 24 located at the rear side of the passage 12.

The license and bill recognition unit 3 is installed in top and bottom sides around the passage 12 behind the sensor switches 13, comprising at least one sampling module 31 and optical recognition module 32. The optical recognition module 32 comprises a plurality of light-transmitting elements 321, a plurality of light-receiving elements 322 respectively axially aimed at the light-transmitting elements 321, and lenses 323 respectively set between the light-transmitting elements 321 and the light-receiving elements 322 near the passage 12.

The bill box 4 is provided at the rear side of the passage 12 and facing the bill-pressing device 24, comprising a bill-bearing board 41 that faces the passage 12 at one side opposite to the bill-pressing device 24 and a plurality of spring members 42 that support the bill-bearing board 41.

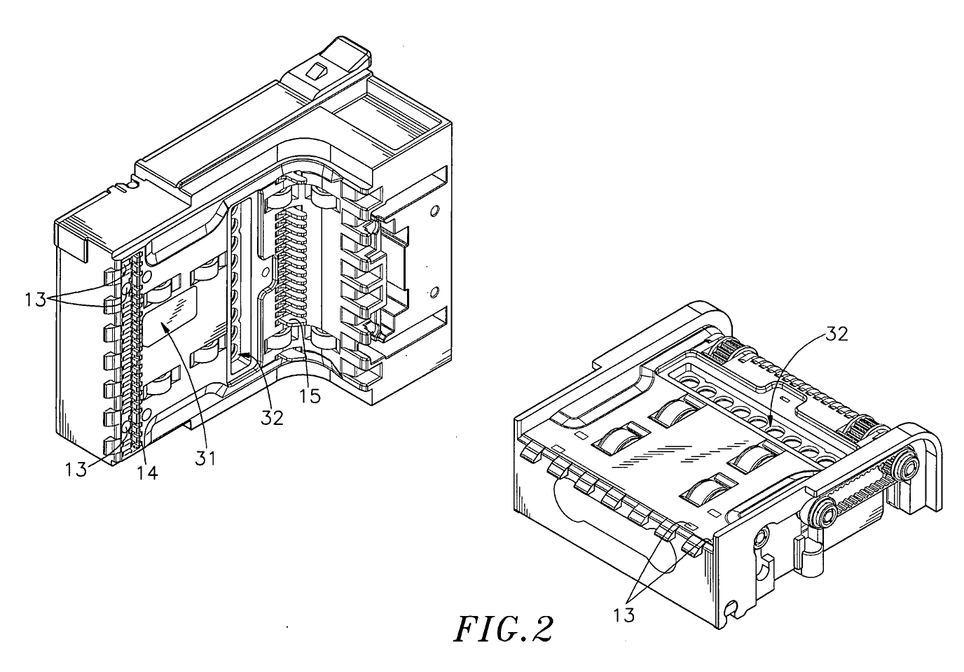

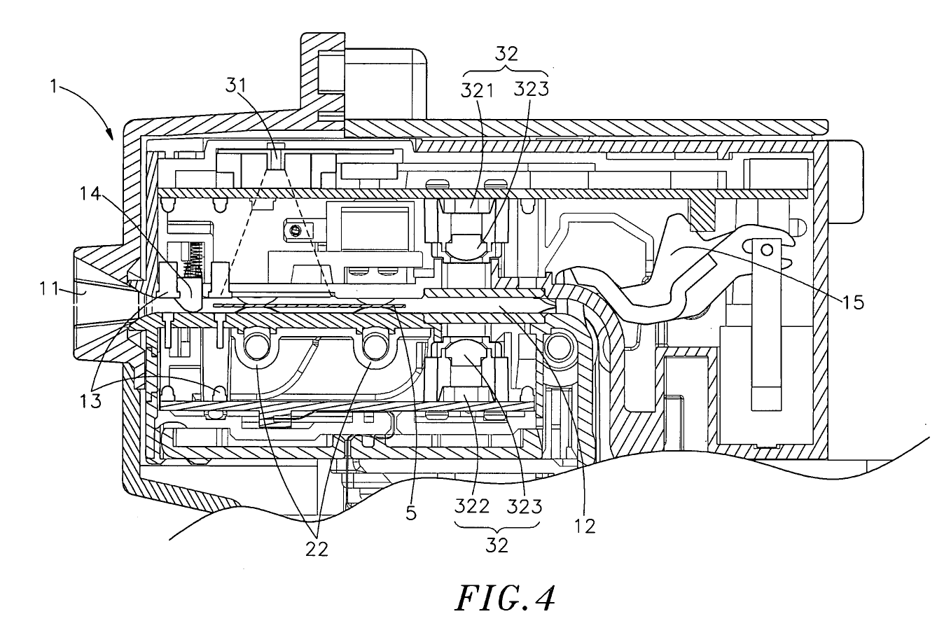

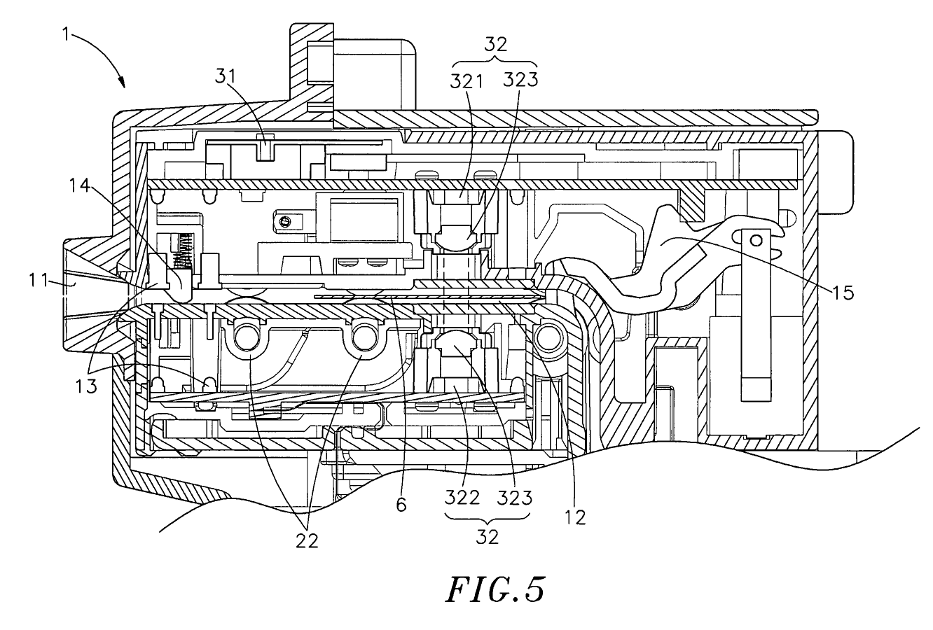

FIGS. 4 and 5 and FIGS. 2 and 3 again, the bill acceptor body 1 is installed in an automatic vending machine. When a user inserts a license 5 or bill 6 into the insertion slot 11, the license 5 or bill 6 shields the sensor switches 13, causing the sensor switches 13 to switch on the light-shielding gate 14, the transmission mechanism 2 and the license and bill recognition unit 3. When the light-shielding gate 14 is opened, the inserted license 5 or bill 6 can then be inserted into the passage 12. At this time, the motor 21 drives the transfer rollers 22 and the transmission belts 23 to transfer the inserted license 5 or bill 6 forwards, and the optical wheel 211 is synchronously rotated by the motor 21, and therefore the sensor 212 counts the number of turns of the optical wheel 211 that is indicative of the revolving speed of the transfer rollers 22. Subject to the number of turns of the optical wheel 211 counted, the moving distance of the inserted license 5 or bill 6 is known. Therefore, the motor 21 can be controlled to control the rotation of the transfer rollers 22, carrying the inserted license 5 or bill 6 to a predetermined location for recognition of the authenticity of the inserted license 5 or bill 6 and the birthday data marked on the inserted license 5 or the value of the bill 6. When the license 5 or bill 6 passed over the sensor switches 13 and the light-shielding gate 14, the sensor switches 13 immediately close the light-shielding gate 14 to protect the passage 12 and the prevent interference of outside light.

The aforesaid motor 21 can be a step motor, server motor or any other suitable design adapted for driving the optical wheel 211, the transfer rollers 22, the transmission belts 23 and the bill-pressing device 24.

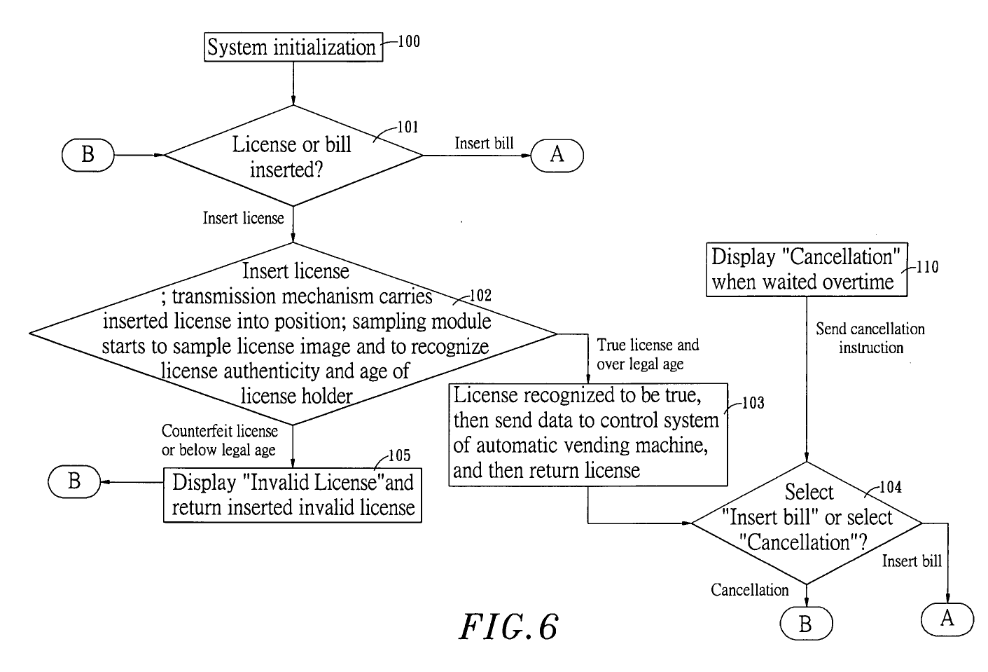

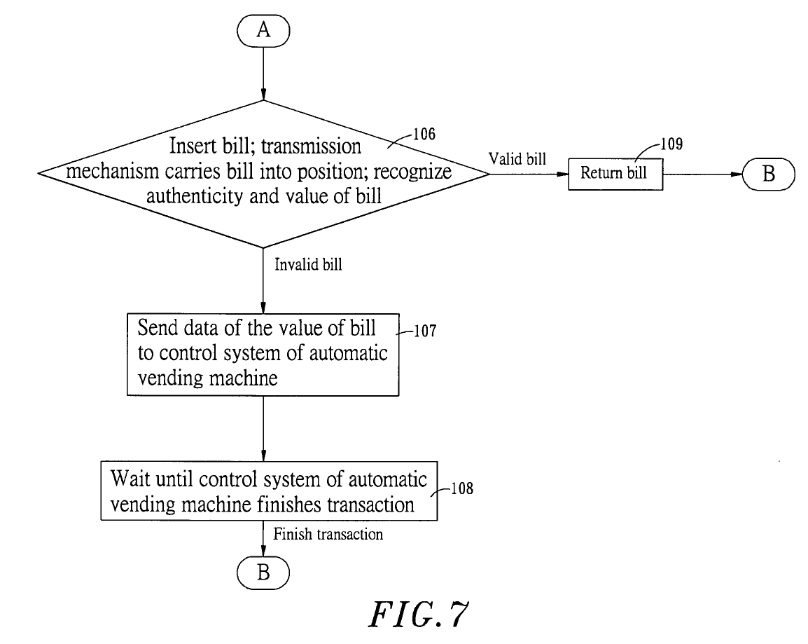

Referring to FIGS. 6 and 7 and FIGS. 2, 4 and 5 again, after installation of the bill acceptor in an automatic vending machine, the bill acceptor operates subject to the following steps:
100 System initialization.
101 Determine whether a license 5 or bill 6 is inserted? And then proceed to step 102 when a license 5 is inserted, or step 106 when a bill 6 is inserted.
102 The transmission mechanism 2 carries the inserted license 5 into position, and the sampling module 31 is started to sample the image of the license 5 and to verify the authenticity of the license 5 and to recognize the age data carried on the license 5. And then proceed to step 103 when the authenticity of the license 5 is OK and the age data meets the requirement (above the set adult threshold level), or step 105 if the license 5 is a counterfeit or the age data does not meet the requirement (below the set adult threshold level).
103 Send the license recognition result to the control system of the automatic vending machine and then rejects the license 5.
104 Select “Insert bill” or select “Cancellation”? And then proceed to step 106 when “Insert bill” is selected, or step 110 when “Cancellation” is selected.
105 Display “Invalid License” and return the inserted invalid license 5, and then proceed to step 101.
106 The transmission mechanism 2 carries the inserted bill 6 into position, and the sampling module 31 is started to sample the image of the inserted bill 6 and to verify the authenticity of the inserted bill 6 and to recognize the value of the inserted bill 6. And then proceed to step 107 when the authenticity of the inserted bill 6 is checked OK, or step 109 if the inserted bill 6 is an invalid bill.
107 Send the data of the value of the inserted bill 6 to the control system of the automatic vending machine.
108 Wait until the control system of the automatic vending machine finishes the transaction, and then return to step 101.
109 Reject the inserted invalid bill 6 and then return to step 101.
110 Display “Cancellation” when waited overtime, and then return to step 104.

When verifying the authenticity of the inserted license 5, the sampling module 31 is controlled to fetch the image of the anti-counterfeit characteristics of the inserted license 5 and to convert the fetched image into digital image data, and then to compare this digital image data with a predetermined reference data in a database, and then to determine the authenticity of the inserted license 5 subject to the comparison result. When the authenticity of the inserted license 5 is confirmed, the sampling module 31 is controlled to fetch the image of the series number of the date of birth from the inserted license 5 and to decode the image into character data by means of optical character recognition (OCR), and the character data thus obtained is compared with the current time, checking whether or not the license holder is over the legal age. The data of the comparison result is sent to the control system of the automatic vending machine for consideration in commodity transactions

Further, if either of the verification of the authenticity of the license 5, the checking of legal age and the recognition of the identification of the holder of the license 5 does not match, the transmission mechanism 2 is reversed to reject the license 5 and then the transaction is terminated. Either the transaction is succeeded or not succeeded after checking of the license 5, the license data such as license characteristics, date of birth of the license holder and license number as well as the transaction time and other transaction related data are recorded for further filing and searching.

Further, the recognition of the license 5 is to recognize the date of birth, name of the license holder of the license 5, and the identification number or license number of the license. Therefore, the customer's name, date of birth and identification number, the transaction item and transaction related data of each transaction are recorded. If the selling commodities are hazardous or controlled products, the data recorded can be used for further filing and searching. The license 5 indicated can be a driver license, identification card, health insurance card, student card, administration card or any of a variety of other types of identify cards.

The aforesaid sampling module 31 comprises an image sensor adapted to fetch the image of the anti-counterfeit characteristics of the inserted license 5 or bill 6. The image sensor can be a charge coupled device (CCD), complementary metal-oxide semiconductor (CMOS) image sensor or any suitable type image sensor. The anti-counterfeit characteristics include watermarking, steel stamp, invisible barcode, laser label and etc.

When a bill 6 enters the passage 12, the optical recognition module 32 of the license and bill recognition unit 3 is started to recognize the bill 6. At this time, the light-transmitting elements 321 transmit light through the bill 6 toward the light-receiving elements 322, and the light-receiving elements 322 receive the light penetrated through the bill 6, and therefore the transmission of the light is measured and compared with a reference value for determining the authenticity and value of the bill 6. The light-transmitting elements 321 emit different wavelengths of visible light (blue light, green light, red light, etc.) and invisible light (ultraviolet light). Therefore, the license and bill recognition unit 3 is practical for the recognition of the authenticity and value of different types of paper currencies issued by different countries.

When the authenticity of the inserted bill 6 is confirmed, the transmission mechanism 2 is started to carry the bill 6 toward the rear side of the passage 12. When the bill 6 is carried to the rear side of the passage 12 between the bill-pressing device 24 and the bill-bearing board 41 of the bill box 4, the bill-pressing device 24 is moved to press the bill 6 onto the bill-bearing board 41 against the spring members 42. Thereafter, the bill-pressing device 24 is returned, and the spring members 42 return the bill-bearing board 41, and therefore the bill 6 is received inside the bill box 4.

The aforesaid bill-pressing device 24 can be a bill-pressing board, a linkage or any suitable mechanism capable of pushing the bill 6 from the passage 12 to the inside of the bill box 4. Because the bill-pressing device 24 is of the known art, no further detailed description is necessary.

Further, the motor 21 of the transmission mechanism 2 utilizes the optical wheel 211 and the sensor 212 to count the number of turns of the transfer rollers 22, and therefore the moving speed and distance of the inserted license 5 or bill 6 are properly controlled. Further, the sampling module 31 of the license and bill recognition unit 3 is set to match the area of the anti-counterfeit characteristics and letters of the license 5. Therefore, when the inserted license 5 enters the passage 12 of the bill acceptor body 1, the sampling module 31 of the license and bill recognition unit 3 accurately reads the license 5 and verifies its authenticity. When a bill 6 is inserted, the optical recognition module 32 of the license and bill recognition unit 3 accurately recognizes the authenticity and value of the inserted bill 6.

After installation of the bill acceptor in an automatic vending machine, the sampling module 31 of the license and bill recognition unit 3 is controlled to verify the authenticity of the inserted license 5 and the age and identity of the license holder to make sure that the license holder is over the legal age, preventing any young person or child to purchase tobacco, wine or other controlled products from the automatic vending machine and avoiding violation to the local law. When the automatic vending machine is selling medicines or other hazardous controlled products, the bill acceptor automatically record the name and date of birth of the license holder, the license or ID number, the transaction time, the commodities purchased and other transaction-related data for further filing and searching. Therefore, the invention eliminates the possibility of threats from evil persons due to vending of controlled products to an illegal person. Further, a chronic patient can directly purchase the desired medicine from the automatic vending machine instead of visiting a hospital. Further, the license photographing and related data recording function of the bill acceptor in every automatic vending machine can be used with street video surveillance and security cameras to constitute a perfect criminal search network, helping the police to combat crime.

Further, the bill acceptor body 1 utilizes the insertion slot 11 and the passage 12 for the insertion of a license 5 or bill 6, and the transmission mechanism 2 carries the inserted license 5 or bill 6 into position for recognition and returns the inserted license 5 or bill 6 to the insertion slot 11 if the inserted license 5 or bill 6 is a counterfeit. Because the bill acceptor of the present invention can recognize licenses as well as bills, the use of the bill acceptor in an automatic vending machine saves much the installation space. Further, because the invention utilizes one single insertion slot 11, passage 12 and transmission mechanism 2 for receiving and carrying licenses 5 and bills 6, the manufacturing cost of the bill acceptor is greatly lowered.

Further, when a user inserts a license 5 into the insertion slot 1, the transmission mechanism 2 immediately carries the inserted license 5 into position for recognition by the license and bill recognition unit 3. After recognition, the transmission mechanism 2 automatically returns the license 5 to the insertion slot 11 so that the user can withdraw the license from the insertion slot 11. When the license 5 is recognized to be a true license and the related data of the license 5 has been recorded, the user is allowed to insert a bill 6 into the insertion slot 11 to make a transaction. Because a user can insert a bill 6 into the insertion slot 11 only after he (she) has inserted the license 5 into the insertion slot 11 for recognition and withdrew the license 5 after completion of recognition of the license 5, the invention prevents the problem that the user forgets to withdraw the license 5. If one's license is left in an automatic vending machine, an evil person may take away the license for illegal purpose. By means of the use of the bill acceptor of the present invention, an automatic vending machine eliminates this possibility.

In general, the invention provides a bill acceptor that has one single insertion slot 11 and one single passage 12 for receiving a license 5 as well as a bill 6 for recognition by a license and bill recognition unit 3 that is comprised of a sampling module 31 and an optical recognition module 32. When a license 5 is inserted, the sampling module 31 recognizes the authenticity of the inserted license and the date of birth of the license holder. When a bill 6 is inserted, the optical recognition module 32 recognizes the authenticity and value of the inserted bill 6. When the bill acceptor is used in an automatic vending machine, the automatic vending machine can be used to sell controlled commodities to qualified persons.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A bill acceptor comprising:
a bill acceptor body, said bill acceptor body having an insertion slot for the insertion of a license as well as a bill and a passage extending from said insertion slot;
a transmission mechanism, said transmission mechanism being comprised of a motor and a plurality of transfer rollers and transmission belts and mounted inside said bill acceptor body and adapted for carrying each inserted license and bill to a respective recognition position for recognition and returning each inserted invalid license and bill from the respective recognition position to said insertion slot; and
a license and bill recognition unit mounted inside said bill acceptor body around said passage, said license and bill recognition unit comprising a sampling module mounted around a front side of said passage adjacent to said insertion slot and adapted for picking up an image of each inserted license and recognizing the authenticity of the license and the data of the date of birth carried on the license, and an optical recognition module mounted around said passage behind said sampling module and adapted for recognizing the authenticity and value of each inserted bill.

2. The bill acceptor as claimed in claim 1, wherein said bill acceptor body comprises a plurality of sensor switches mounted in said passage in front of said sampling module and adapted for detecting moving in and moving out of every inserted license and bill, and a light-shielding gate set between said insertion slot and said passage and controllable by said sensor switches to close/open said passage.

3. The bill acceptor as claimed in claim 1, wherein said passage turns vertically downwards on the middle.

4. The bill acceptor as claimed in claim 1, wherein said bill acceptor body comprises an anti-theft hook mounted in said passage behind said optical recognition module of said license and bill recognition unit.

5. The bill acceptor as claimed in claim 1, wherein said bill acceptor body further comprises a bill box disposed at one side along a rear part of said passage and adapted for receiving every inserted and recognized bill, and a bill-pressing device disposed along the rear part of said passage opposite to said bill box and movable by said transmission mechanism to push the inserted bill out of said passage into said bill box.

6. The bill acceptor as claimed in claim 5, wherein said bill box comprises a plurality of spring members adapted to impart a spring force, and a bill-bearing board supported on said spring members and facing said bill-pressing device adapted for receiving each bill being moved out of said passage by said bill-pressing device.

7. The bill acceptor as claimed in claim 1, wherein said license and bill recognition unit is mounted inside said bill acceptor body in top and bottom sides relative to said passage.

8. The bill acceptor as claimed in claim 1, wherein said optical recognition module comprises a plurality of light-transmitting elements arranged at one side relative to said passage, a plurality of light-receiving elements arranged at an opposite side relative to said passage and respectively axially aimed at said light-transmitting elements, and a plurality of lenses set in between said light-transmitting elements and said light-receiving elements.

9. The bill acceptor as claimed in claim 1, wherein said sampling module comprises a charge coupled device type image sensor.

10. The bill acceptor as claimed in claim 1, wherein said sampling module comprises a complementary metal-oxide semiconductor image sensor.

11. The bill acceptor as claimed in claim 1, wherein said transmission mechanism comprises an optical wheel and a sensor adapted to count the speed and number of turns of said transfer rollers.
